(19) United States
(12) Patent Application Publication
(10) Pub. No.: US 2026/0214198 A1
(43) Pub. Date: Jul. 23, 2026

(54) IMAGE DISPLAY DEVICE, IMAGE DISPLAY METHOD, AND NON-TRANSITORY STORAGE MEDIUM

(71) Applicant: JVCKENWOOD Corporation, Yokohama-shi (JP)

(72) Inventor: Fumihiko Ito, Yokohama-shi (JP)

(21) Appl. No.: 19/571,585

(22) Filed: Mar. 19, 2026

Related U.S. Application Data
(63) Continuation of application No. PCT/JP2024/025908, filed on Jul. 19, 2024.

(30) Foreign Application Priority Data
Sep. 22, 2023 (JP) 2023-159146
Mar. 25, 2024 (JP) 2024-048457

(51) Int. Cl. H04N 13/383; H04N 13/00; H04N 13/324; H04N 13/327

(52) U.S. Cl. CPC H04N 13/383; H04N 13/324; H04N 13/327; H04N 2013/0077

(57) ABSTRACT

An image display device includes: a display device provided with pixels serving as light sources; a memory that stores computer executable instructions; and a processor that executes the computer executable instructions to perform operations, comprising: detecting a line of sight of a user; rendering, in the display device, a stereoscopic image according to the detected line of sight; identifying an unnecessary light source range of light sources for an optical crosstalk which is emitted from the light sources other than those for the stereoscopic image and which passes through a position of the stereoscopic image; identifying, in the unnecessary light source range, the light source pixels for the optical crosstalk; and performing a predetermined processing with respect to the identified light source pixels or the light beams emitted therefrom to prevent the emitted light beams from passing through the position of the stereoscopic image.

### CROSS-REFERENCE TO RELATED APPLICATIONS

This application is a Continuation of PCT International Application No. PCT/JP2024/025908 filed on Jul. 19, 2024 which claims the benefit of priority from Japanese Patent Application No. 2023-159146, filed on Sep. 22, 2023 and Japanese Patent Application No. 2024-048457, filed on Mar. 25, 2024, the entire contents of all of which are incorporated herein by reference.

### FIELD OF THE INVENTION

The present application is related to an image display device, an image display method, and a non-transitory storage medium.

### BACKGROUND OF THE INVENTION

For example, the development is underway for a light-field display in which light beams sent out by an object, which is captured by a light-field camera, are reproduced on a display.

In Japanese Patent Application Laid-open No. H10-319342, an eyeball-projection video display device is disclosed that includes a field lens; a microlens array disposed behind the field lens; and a light-emitting display device such as an LED array that is disposed behind the microlens array and that functions as a video display unit.

However, in a light-field display, sometimes there occurs crosstalk by the light emission from pixels other than the pixels serving as the light sources for generating the intended stereoscopic images to thus impact on stereoscopic images, and it results in blurring, uneven colors, and uneven brightness.

### SUMMARY OF THE INVENTION

An image display device, an image display method, and a non-transitory storage medium are disclosed.

According to one aspect of the present application, there is provide an image display device comprising: a display device provided with pixels serving as light sources; a memory that is configured to store computer executable instructions; and a processor that is configured to execute the computer executable instructions to perform operations, comprising: detecting a line of sight of a user; rendering, in the display device, a stereoscopic image according to the line of sight of the user; identifying an unnecessary light source range indicating a range of candidate pixels serving as light sources for an optical crosstalk which represents light beams emitted from the light sources other than the light sources for the rendered stereoscopic image and which passes through a position of the stereoscopic image; identifying, from among the pixels present in the unnecessary light source range, the light source pixels which represent the pixels serving as the light sources for the optical crosstalk; and performing a predetermined processing with respect to the identified light source pixels or with respect to the light beams emitted from the identified light source pixels to prevent the light beams emitted from the identified light source pixels from passing through the position of the stereoscopic image.

According to one aspect of the present application, there is provide an image display method comprising: detecting a line of sight of a user; rendering, in a display device provided with pixels serving as light sources, a stereoscopic image according to the line of sight of the user; identifying an unnecessary light source range indicating a range of candidate pixels serving as light sources for an optical crosstalk which represents light beams emitted from the light sources other than the light sources for the rendered stereoscopic image and which passes through a position of the stereoscopic image; identifying, from among pixels present in the unnecessary light source range, light source pixels which represent pixels serving as the light sources for the optical crosstalk; and performing a predetermined processing with respect to the identified light source pixels or with respect to the light beams emitted from the identified light source pixels to prevent the light beams emitted from the identified light source pixels from passing through the position of the stereoscopic image.

According to one aspect of the present application, there is provide a non-transitory storage medium that stores a computer program that causes the computer to execute: detecting a line of sight of a user; rendering, in a display device provided with pixels serving as light sources, a stereoscopic image according to the line of sight of the user; identifying an unnecessary light source range indicating a range of candidate pixels serving as light sources for an optical crosstalk which represents light beams emitted from the light sources other than the light sources for the rendered stereoscopic image and which passes through a position of the stereoscopic image; identifying, from among pixels present in the unnecessary light source range, light source pixels which represent pixels serving as the light sources for the optical crosstalk; and performing a predetermined processing with respect to the identified light source pixels or with respect to the light beams emitted from the identified light source pixels to prevent the light beams emitted from the identified light source pixels from passing through the position of the stereoscopic image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary configuration of an image display device according to the present application;

FIG. 2 is a diagram illustrating an exemplary configuration of a control device according to the present application;

FIG. 3 is a diagram illustrating an example of information stored in a map information storage of the control device according to the present application;

FIG. 4 is a diagram illustrating an example of information stored in a rendering video storage according to the present application;

FIG. 5 is a diagram illustrating an exemplary configuration of a line of sight detecting unit of the control device according to the present application;

FIG. 6 is a diagram for explaining an image rendering process performed in the image display device according to the present application;

FIG. 7 is a diagram for explaining about crosstalk that can possibly occur during the rendering performed in the image display device according to the present application;

FIG. 8 is a diagram for explaining about the description of a light beam based on the plenoptic function;

FIG. 9 is a diagram for explaining about processes performed by a range identifying unit and a turn-off instruction unit of the image display device according to the present application;

FIG. 10 is a diagram illustrating an exemplary configuration of a light beam processing unit of the control device according to the present application;

FIG. 11 is a diagram for explaining about a process performed by the light beam processing unit of the image display device according to the present application;

FIG. 12 is a diagram for explaining about a blocking filter of the image display device according to the present application;

FIG. 13 is a diagram illustrating an exemplary configuration of a display device according to the present application; and

FIG. 14 is a flowchart for explaining about a flow of an image display method according to the present application.

### DETAILED DESCRIPTION OF THE INVENTION

An exemplary embodiment of the present application is described below in detail with reference to the accompanying drawings. However, the present application is not limited by the embodiment described below.

### Configuration of Image Display Device

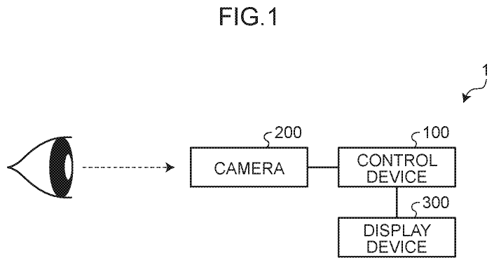

Firstly, explained below with reference to FIG. 1 is a configuration of an image display device 1 according to the present application. FIG. 1 is a diagram illustrating an exemplary configuration of the image display device according to the present application. As illustrated in FIG. 1, the image display device 1 according to the present application includes a control device 100, a camera 200, and a display device 300. Given below is a brief explanation about those constituent elements.

The control device 100 performs a variety of arithmetic process and performs processes for implementing functions; as well as controls the display device 300 to render stereoscopic images. Based on a face image of a user captured by the camera 200, the control device 100 detects a line of sight of the user and displays a stereoscopic image in the display device 300 according to the detected line of sight.

The camera 200 captures a face image of the user. The camera 200 includes optical devices and an imaging device. The optical devices are devices such as a lens, a mirror, and a filter that constitute an optical system. The imaging device converts light, which falls thereon after passing through the optical devices, into image signals representing electrical signals. For example, the imaging device can be a CCD sensor (CCD stands for Charge Coupled Device) or a CMOS sensor (CMOS stands for Complementary Metal Oxide Semiconductor).

The display device 300 displays stereoscopic images. The display device 300 can be a light-field display. In a light-field display, a stereoscopic image is displayed when the light beams sent out by an object are reproduced by allowing the light beams emitted from the display to pass through a microlens to be refracted. For example, a light-field display can be implemented according to integral imaging.

Meanwhile, the image display device 1 need not be an all-in-one device that includes the control device 100, the camera 200, and the display device 300. Thus, each of those devices can be an independent device. Alternatively, for example, the control device 100, the camera 200, and the display device 300 can be connected to a network and can send and receive information among themselves via the network. In that case, the image display device 1 can be called an image display system that includes the control device 100, the camera 200, the display device 300, and the network.

### Configuration of Control Device

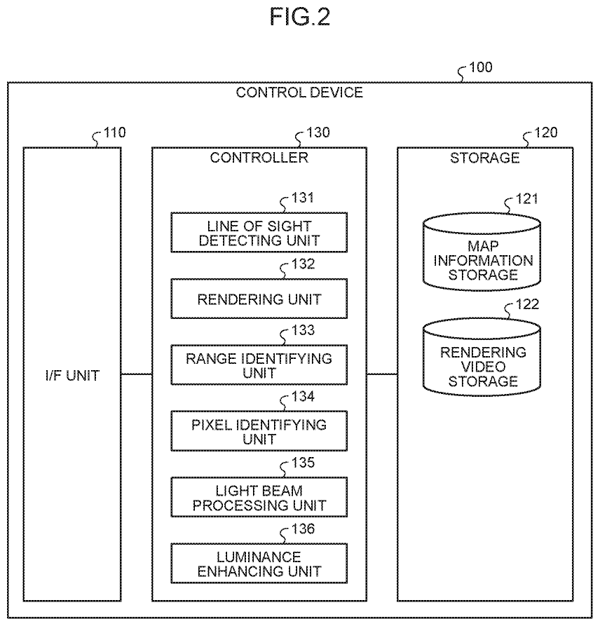

Explained below with reference to FIG. 2 is a configuration of the control device 100 according to the present application. FIG. 2 is a diagram illustrating an exemplary configuration of the control device according to the present application. As illustrated in FIG. 2, the control device 100 according to the present application includes an interface (I/F) unit 110, a storage 120, and a controller 130. The explanation about those constituent elements is given below in a sequential manner.

The I/F unit 110 is responsible for enabling transmission and reception of control signals and video signals between the camera 200 and the display device 300 in a wired manner or a wireless manner. The wired communication can be implemented using, for example, a USB (which stands for Universal Serial Bus), or an SDI (which stands for Serial Digital Interface), or an HDMI (which is a registered trademark and which stands for High-Definition Multimedia Interface). The wireless communication can be implemented using a wireless LAN as defined in IEEE 801.11 (LAN stands for Local Area Network).

The storage 120 is a storage device for storing a variety of information. The storage 120 includes a main storage device and an auxiliary storage device. The main storage device can be implemented using a semiconductor memory device such as a random access memory (RAM), a read only memory (ROM), or a flash memory. The auxiliary storage device can be implemented using, for example, a hard disk or a solid state drive (SSD).

As illustrated in FIG. 2, the storage 120 includes a map information storage 121 and a rendering video storage 122. The explanation about those constituent elements is given below in a sequential manner.

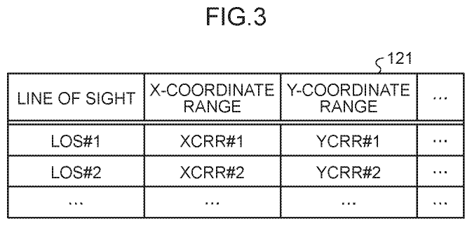

The map information storage 121 stores therein information about a relationship between the line of sight and an unnecessary light source range. Explained below with reference to FIG. 3 is an example of the information stored in the map information storage 121. FIG. 3 is a diagram illustrating an example of the information stored in the map information storage of the control device according to the present application.

As illustrated in FIG. 3, the map information storage 121 stores therein the information about items “line of sight”, “X-coordinate range”, and “Y-coordinate range”.

The item “line of sight” indicates information about the line of sight of the user. For example, the information about the line of sight of the user expressed using the plenoptic function can be stored in the item “line of sight”. The item “X-coordinate range” indicates a value of the X coordinate of the unnecessary light source range corresponding to the item “line of sight”. The item “Y-coordinate range” indicates a value of the Y coordinate of the unnecessary light source range corresponding to the item “line of sight”. The X-coordinate and the Y-coordinate represent the coordinates of a position on the surface of a flat panel display 310 and are in a mutually perpendicular relationship.

Thus, in the example illustrated in FIG. 3, an X-coordinate range “XCRR #1” in the unnecessary light source range and a Y-coordinate range “YCR #1” in the unnecessary light source range are stored in a corresponding manner to a line of sight “LOS #1”.

Meanwhile, the map information storage 121 is not limited to store the information about the items “line of sight”, “X-coordinate range”, and “Y-coordinate range”, and it is also possible to store information about a relationship between other arbitrary lines of sight and unnecessary light source ranges.

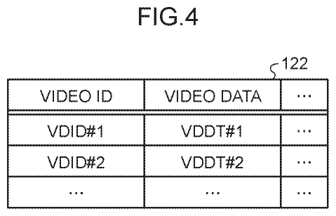

The rendering video storage 122 stores therein information about videos to be rendered in the display device 300. Explained below with reference to FIG. 4 is an example of the information stored in the rendering video storage 122. FIG. 4 is a diagram illustrating an example of the information stored in the rendering video storage according to the present application.

As illustrated in FIG. 4, the rendering video storage 122 stores therein the information about items “video ID” and “video data”.

The item “video ID” indicates an identifier for enabling identification of a rendering video and is expressed using characters or numbers. The item “video data” indicates video data of the rendering video that is identified by the video ID specified in the item “video ID”, and for example, can represent the video data captured using a light-field camera or the video data generated using computer graphics (CG).

Thus, in the example illustrated in FIG. 4, video data “VDDT #1” of a rendering video identified by a video ID “VDID #1” is stored.

Meanwhile, the rendering video storage 122 is not limited to store the information about the items “video ID” and “video data”, and it is also possible to store information about other arbitrary videos to be rendered in the display device 300.

The controller 130 is a controller that performs a variety of arithmetic process and performs processes for implementing functions. The controller 130 is implemented when a central processing unit (CPU) or a micro processing unit (MPU) executes various computer programs stored in the storage 120 by using the RAM as the work area. Alternatively, the controller 130 can be implemented by using an integrated circuit such as an application specific integrated circuit (ASIC) or a field programmable gate array (FPGA).

As illustrated in FIG. 2, the controller 130 includes an line of sight detecting unit 131, a rendering unit 132, a range identifying unit 133, a pixel identifying unit 134, a light beam processing unit 135, and a luminance enhancing unit 136. The controller 130 reads computer programs (software) from the storage 120 and executes them to implement the abovementioned functions and perform the corresponding processes. Alternatively, the abovementioned functions of the controller 130 can be implemented by using an electronic circuit. Meanwhile, the controller 130 can perform the processes by using only a single CPU, or can include a plurality of CPUs and can perform the processes by using those CPUs parallelly. The explanation about the abovementioned constituent elements is given below in a sequential manner.

The line of sight detecting unit 131 detects the line of sight of the user based on the image data acquired by capturing the face of the user. That is, the line of sight detecting unit 131 performs image processing and detects the face of the user from the image data. More particularly, the line of sight detecting unit 131 can have the following configuration for detecting the line of sight of the user.

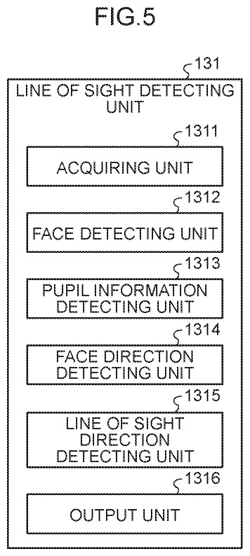

Regarding the configuration of the line of sight detecting unit 131, the explanation is given below with reference to FIG. 5. FIG. 5 is a diagram illustrating an exemplary configuration of the line of sight detecting unit of the control device according to the present application. As illustrated in FIG. 5, the line of sight detecting unit 131 includes an acquiring unit 1311, a face detecting unit 1312, a pupil information detecting unit 1313, a face direction detecting unit 1314, a line of sight direction detecting unit 1315, and an output unit 1316. The explanation about those constituent elements is given below in a sequential manner.

The acquiring unit 1311 acquires the image data captured by the camera 200. The image data acquired by the acquiring unit 1311 contains the face of the user. Upon acquiring the image data, the acquiring unit 1311 stores the image data in the storage 120 and outputs it to the face detecting unit 1312.

From the image data acquired by the acquiring unit 1311, the face detecting unit 1312 detects a face region that includes at least some portion of the face of the user. For example, the face detecting unit 1312 can detect the face region using a classifier that is based on a convolutional neural network (CNN) learnt in advance for a face detection. Herein, the face region is detected as, for example, a rectangular region having approximately the same size as a region including the entire face.

The pupil information detecting unit 1313 detects pupil information, which represents information about the pupils of the user, based on the image data. For example, the pupil information contains coordinate data indicating pupillary margins of the user or contains information indicating a length, such as the radius or the diameter, of the pupillary margins of the user, and contains coordinate data of pupil centers of the user. Firstly, from the face region detected by the face detecting unit 1312, the pupil information detecting unit 1313 detects eye regions that include eyes of the user. Herein, the eye regions can be detected using a classifier that is based on the CNN learnt in advance for the face detection. Then, the pupil information detecting unit 1313 detects pupils of the user. The eye regions can be narrowed down based on a predetermined standard, and accordingly the regions assumed to include the pupils are detected. Based on that, the information about the coordinate data indicating the pupillary margins or the information indicating the length, such as the radius or the diameter, of the pupillary margins is detected, and the coordinate data of the pupil centers is detected.

From the face region detected by the face detecting unit 1312, the face direction detecting unit 1314 detects feature points of the face and, from a pattern of the detected feature points, detects face direction information indicating the direction of the face of the user. The operation of extracting the feature points of the face from the face region can be performed using a classifier that is based on a CNN trained in facial features in advance. Herein, the feature points of the face represent one or more points at a characteristic position in each of parts constituting a face, such as outer corners of the eyes, inner corners of the eyes, an outline of the face, a bridge of the nose, corners of the mouth, and the eyebrows.

Based on the pupil information detected by the pupil information detecting unit 1313 and based on the face direction information detected by the face direction detecting unit 1314, the line of sight direction detecting unit 1315 detects the line of sight indicating the line of sight of the user. The line of sight direction detecting unit 1315 can detect the line of sight information by implementing, with respect to the pupil information and the face direction information, a known line of sight detecting process in which the line of sight is detected using, for example, a three-dimensional eye model. Herein, the line of sight information can contain a vector that indicates the line of sight of the user in a three-dimensional manner, or can contain coordinate data of the point of gaze on a predetermined target surface (for example, the display device 300).

The output unit 1316 outputs the line of sight of the user detected by the line of sight direction detecting unit 1315. More particularly, the output unit 1316 outputs the detected line of sight of the user to the rendering unit 132 and the range identifying unit 133.

The rendering unit 132 renders, in the display device 300, a stereoscopic image according to the line of sight of the user. That is, the rendering unit 132 issues a rendering instruction to the display device 300 to ensure that the stereoscopic image is positioned in the line of sight of the user. In accordance with the positions of the eyes and the line of sight of the user, the rendering unit 132 obtains pixel positions in the flat panel display 310 in which light beams would be generated for reproducing the stereoscopic image, and, upon factoring in the pixel colors, causes the pixels to perform light emission at a brightness corresponding to the image signals. More particularly, the following operations can be performed.

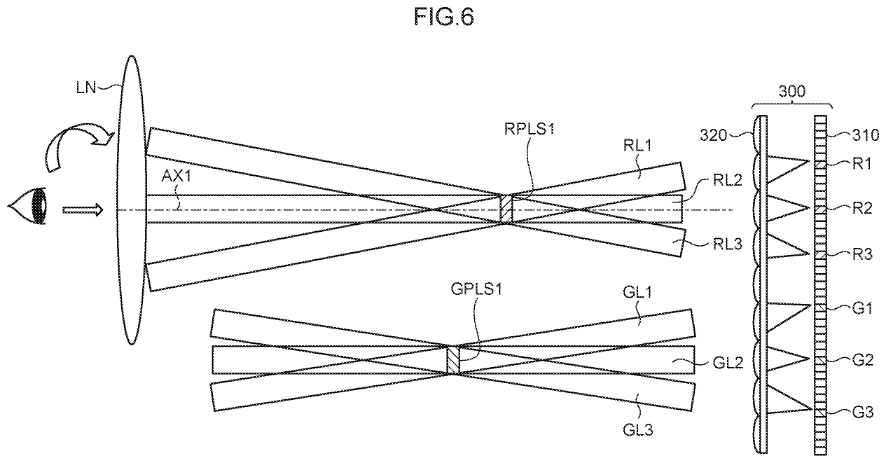

The processes performed by the rendering unit 132 are explained below with reference to FIG. 6. FIG. 6 is a diagram for explaining an image rendering process performed in the image display device according to the present application. In FIG. 6 are illustrated the flat panel display 310 (explained later), a microlens array 320, a lens LN which expands a pupil of an eye of the user, and a line of sight AX1 of the user. As illustrated in FIG. 6, the rendering unit 132 issues a rendering instruction to the flat panel display 310 of the display device 300, and causes the pixels of the flat panel display 310 to emit light. For example, the rendering unit 132 turns on red light emitters R1, R2, R3 illustrated in FIG. 6. As a result, red light beams RL1, RL2, and RL3 get mixed and a red stereoscopic image RPLS1 gets formed. In an identical manner, the rendering unit 132 causes green light emitters G1, G2, and G3 illustrated in FIG. 6 to emit light. As a result, green light beams GL1, GL2, and GL3 get mixed and a green stereoscopic image GPLS1 is formed.

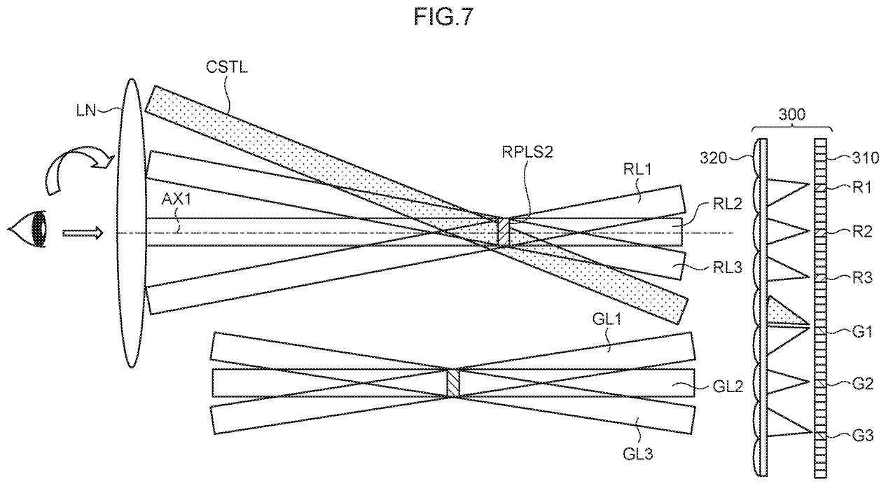

Subsequently, regarding the crosstalk, the explanation is given with reference to FIG. 7. FIG. 7 is a diagram for explaining about the crosstalk that can possibly occur during the rendering performed in the image display device according to the present application. As illustrated in FIG. 7, when the red light emitters R1, R2, and R3 are turned on and a red stereoscopic image RPLS2 is formed, assume that the green light emitters G1, G2, and G3 are also turned on. In that case, as illustrated in FIG. 7, optical crosstalk CSTL of the green light beam, which is emitted from the green light emitter G1, passes through the position at which the red stereoscopic image RPLS2 is formed. Hence, the green color gets mixed in the red stereoscopic image RPLS2, and thus the crosstalk occurs. As illustrated in FIG. 7, when the color of the optical crosstalk is different, there occurs mixing of colors in the stereoscopic image and it leads to a different color from the original color. For example, on a dark red background, a slightly bright yellow spot gets formed that is particularly noticeable. Even when the optical crosstalk is also attributed to the light coming from the same red pixels, the reproduced stereoscopic image becomes slightly blurred or becomes partially brighter than the original brightness.

The range identifying unit 133 identifies an unnecessary light source range indicating a range of candidate pixels serving as the light sources for optical crosstalk which are emitted from the light sources other than the light sources for the rendered stereoscopic image and which pass through the position of the stereoscopic image. That is, it can be said that the range identifying unit 133 identifies the range in which the pixels serving as the light source for optical crosstalk may be present.

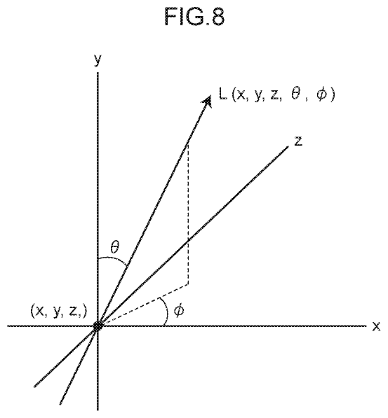

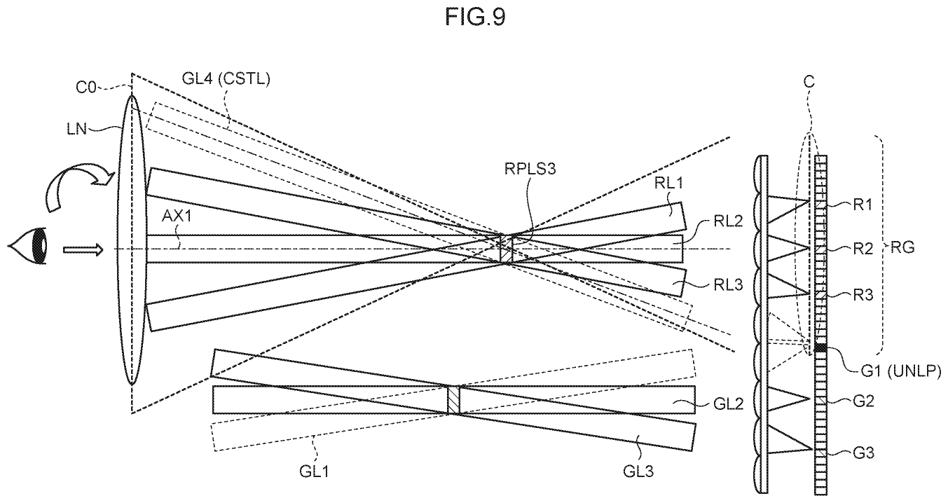

More particularly, based on the size of the pupils of the user and based on the positional relationship between the pupils of the user, the stereoscopic image, and the flat panel display, the range identifying unit 133 identifies the unnecessary light source range. Regarding the processes performed by the range identifying unit 133, the explanation is given below with reference to FIGS. 8 and 9.

FIG. 8 is a diagram for explaining about a description of a light beam based on the plenoptic function. As illustrated in FIG. 8, generally, an arbitrary light beam L can be expressed using the three-dimensional space (x, y, z), which represents the light emission position, and the two-dimensional space (θ,99 ), which represents the direction, according to the plenoptic function introduced by Adelson and Bergen.

With reference to FIG. 9, consider a case of using a light field display. FIG. 9 is a diagram for explaining about the processes performed by the range identifying unit and a turn-off instruction unit of the image display device according to the present application. Herein, (x, y, z) represent the position coordinates of a spatial stereoscopic image to be displayed, and (θ,99 ) represents the line of sight direction toward the pupil detected by the line of sight detecting unit 131. With them, a visual axis AX1 gets decided that connects the pupil, the spatial stereoscopic image, and the central pixel of the flat panel display 310 for displaying the spatial stereoscopic image. Subsequently, centered around the pupil, a virtual pupil circle C0 which is slightly greater in size than the pupil size is assumed, and a range in which a circle C is projected onto the flat panel display 310 is identified as an unnecessary light source range RG, the circle C being obtained by downsizing the virtual pupil circle C0 according to proportionality between a distance from the spatial stereoscopic image to the pupil and a distance from the spatial stereoscopic image to the flat panel display 310. That is, the pixels that are present within the unnecessary light source range RG and that are different from the pixels for displaying the stereoscopic image represent the candidate pixels that may cause the crosstalk.

For example, assume that the pupil side circle has a radius of 4 mm, and assume that a stereoscopic image that is displayed by 50 mm in front of the flat panel display 310 positioned at 600 mm, that is, displayed at 550 mm ahead from the pupil side is being looked at. In that case, according to the proportionality, the circle on the flat panel display 310 has the radius of 0.37 mm, and it can be determined that the pixels other than the pixels that are present within the abovementioned circle and that are for displaying the stereoscopic image may be cause the crosstalk.

Moreover, as the unnecessary light source range, by taking into account a discriminative field of vision representing the range within which a sharp vision can be gained without moving the pupils, the range identifying unit 133 can identify the range corresponding to a predetermined angle around the line of sight as the unnecessary light source range. That is, by taking into account the visual field characteristics of the human eye, the range identifying unit 133 can set the unnecessary light source range, which is for checking whether or not the optical crosstalk has occurred, to about ±2.5° around the line of sight of the discriminative field of vision which represents the range within which a sharp vision can be gained without moving the pupils. As a result, in the range in which the vision is sharp and the crosstalk is noticeable, it becomes possible to prevent the crosstalk in an efficient manner, and to reproduce high-quality stereoscopic images.

More particularly, centered around the line of sight around the stereoscopic image displayed at 550 mm ahead, the radius of (24 mm)+(0.37 mm) corresponding to ±2.5° serves as the range for crosstalk checking. In the case of looking at the range separated from the central field of vision by ±2.5° or more, it is natural to have the eyeball movement occurring in that direction. Hence, the line of sight changes, and the rendering state also changes. Thus, there is no need to take measures by constantly paying attention to the optical crosstalk at a position separated by ±2.5° or more. Meanwhile, regarding the visual field characteristics, the range within which a person can gain a sharp vision without moving the eyeballs (i.e., the discriminative field of vision) is about ±1.5° to ±2.5°

Moreover, based on the line of sight, by reading the unnecessary light source range from the map information storage 121, the range identifying unit 133 can identify the unnecessary light source range corresponding to the line of sight. As explained above, in the map information storage 121, the unnecessary light source range corresponding to each of the line of sight is stored in advance. For that reason, if the line of sight detecting unit 131 is able to detect the line of sight of the user, the unnecessary light source range corresponding to the line of sight can be read from the map information storage 121. Thus, it becomes possible to identify the unnecessary light source range.

Meanwhile, when multiple users are present, according to the line of sight of each of the multiple users detected by the line of sight detecting unit 131, the range identifying unit 133 can perform the abovementioned processes for each of the multiple users and identify the corresponding unnecessary light source range.

The pixel identifying unit 134 identifies, from among the pixels present in the unnecessary light source range, the light source pixels that represent the pixels serving as the light sources for the optical crosstalk. More particularly, from among the pixels present in the unnecessary light source range, the pixel identifying unit 134 identifies, as the pixels related to the occurrence of the crosstalk, such pixels as the straight line connecting each of the pixels with the center of the corresponding microlens passes through the stereoscopic image.

More particularly, from among the pixels present in the unnecessary light source range, the pixel identifying unit 134 identifies, as the pixels contributing to the crosstalk, such pixels as the straight line connecting each of the pixels with the center of the corresponding microlens passes through the stereoscopic image. With reference to FIG. 9, the green light beam GL4, which is emitted from the green light emitter G1 positioned within the unnecessary light source range, passes through the microlens and through a red stereoscopic image RPLS3. Hence, the green light beam GL4 is identified as the optical crosstalk CSTL.

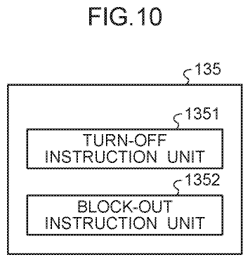

The light beam processing unit 135 performs a predetermined processing with respect to the identified light source pixels or with respect to the light beams emitted from those light source pixels for preventing the light beams emitted from the light source pixels from passing through the position of the stereoscopic image. Regarding a configuration of the light beam processing unit 135 that performs such processing, the explanation is given below with reference to FIG. 10. FIG. 10 is a diagram illustrating an exemplary configuration of the light beam processing unit of the control device according to the present application. As illustrated in FIG. 10, the light beam processing unit 135 according to the present application includes at least one of a turn-off instruction unit 1351 and a block-out instruction unit 1352.

The turn-off instruction unit 1351 enables to turn off the light emission of the identified light source pixels. That is, when the turn-off instruction unit 1351 is included, the light beam processing unit 135 issues a turn-off instruction to the pixels identified by the pixel identifying unit 134 and turns off the light emission of the identified pixels to prevent the light beams emitting from the light source pixels from passing through the position of the stereoscopic image. With reference to FIG. 9, when the green light emitter G1 is identified as the pixel representing the light source for the optical crosstalk and when the green light emitter G1 is turned off, the optical crosstalk CSTL and the green light beam GL1 disappear. In this way, since it is possible to turn of the light emission of the pixels for the crosstalk, the crosstalk can be suppressed in an appropriate manner. Meanwhile, in a display, generally, the pixel that unnecessarily emit light due to defective light is more noticeable than a black point which does not emit light. Hence, it is advantageous to ensure that the optical crosstalk is not emitted.

Meanwhile, alternatively, the turn-off instruction unit 1351 can check whether the color of the pixel for the crosstalk is different from the color of the stereoscopic image, and only when the color of the optical crosstalk is different from the color of the stereoscopic image, can turn off the pixel for the optical crosstalk. In this way, since the crosstalk is most noticeable in the case of color difference, the crosstalk having the same color can be ignored to thereby make the processing simpler.

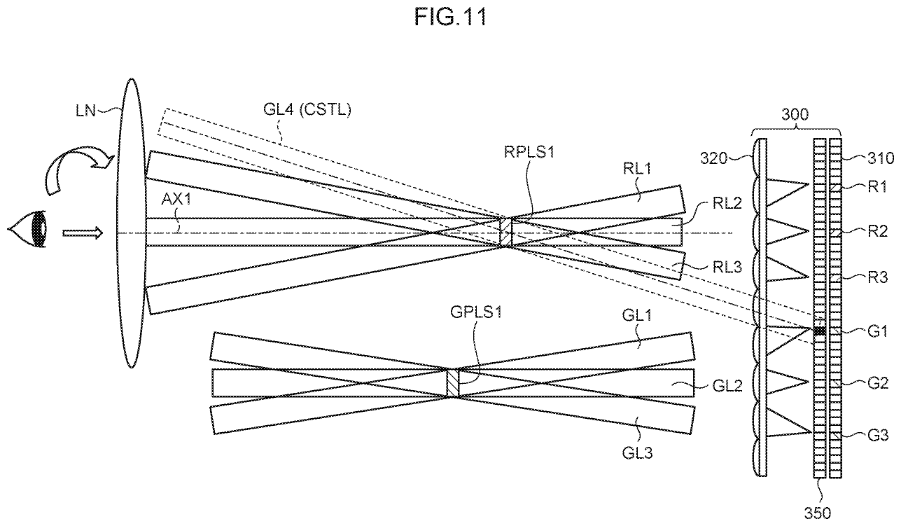

The block-out instruction unit 1352 issues an instruction to a blocking filter 350, which is disposed between the flat panel display 310 and the microlens array 320, to block out those pixels of the blocking filter 350 which correspond to the positions of the identified light source pixels. That is, when the block-out instruction unit 1352 is included, the light beam processing unit 135 blocks out those pixels of the blocking filter 350 which correspond to the positions of the identified light source pixels to block out the light beams emitted from the identified light source pixels at the blocking filter 350 and prevent the light beams emitted from the identified light source pixels from passing through the position of the stereoscopic image. Regarding the processes performed by the block-out instruction unit 1352, specific explanation is given below with reference to FIG. 11.

FIG. 11 is a diagram for explaining about the processes performed by the block-out instruction unit of the image display device according to the present application. As illustrated in FIG. 11, the display device 300 can include the blocking filter 350 between the front side of the flat panel display 310 and the microlens array 320. Regarding the configuration of the blocking filter 350, the explanation is given later.

As illustrated in FIG. 11, the block-out instruction unit 1352 issues an instruction to block out those pixels of the blocking filter 350 which correspond to the positions of the identified light source pixels, and ensures that the light beam GL4 emitted from the identified light source pixel (the green light emitter G1) does not pass through the position of the stereoscopic image. As a result, the light beams that are emitted from the pixels for the crosstalk can be blocked and can be prevented from passing through the position of the stereoscopic image. As a result, it becomes possible to suppress the crosstalk in an appropriate manner.

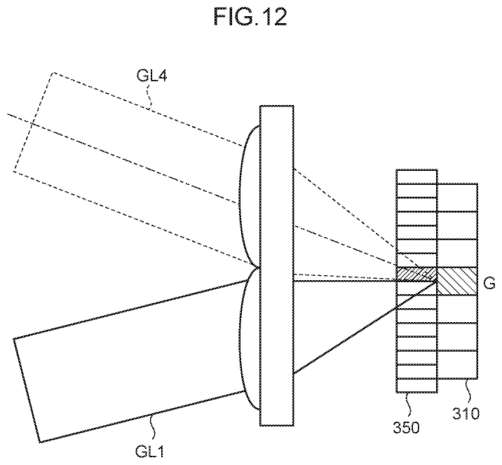

Meanwhile, in the blocking filter 350, the size of a single pixel can be half the size of a pixel of the flat panel display 310. Regarding such a form of the blocking filter 350, the explanation is given below with reference to FIG. 12. FIG. 12 is a diagram for explaining about the blocking filter of the image display device according to the present application. As illustrated in FIG. 12, in the blocking filter 350, the size of a single pixel can be half the size of a pixel of the flat panel display 310.

Meanwhile, between the two pixels of the blocking filter 350 corresponding to the position of each identified light source pixel, that is, between the two pixels of the blocking filter 350 that face the identified light source pixel at a right angle, the block-out instruction unit 1352 can issue a blocking instruction to the pixel present on the side toward the stereoscopic image in which the crosstalk occurs. With reference to the example illustrated in FIG. 12, the light beam GL1 emitted from a light source G passes through the blocking filter 350 as normal and enables formation of a stereoscopic image. Hence, as compared to the case in which the light source G is turned off, it becomes possible to suppress a decline in the luminance of the stereoscopic image attributed to the light beams emitted from the light source G. That is, in addition to suppress the crosstalk attributed to the light emission from the pixels for the crosstalk, it also becomes possible to suppress the decline in the luminance of another stereoscopic image in which the crosstalk does not occur.

In order to compensate for luminance of the stereoscopic image that is impacted by turning off the pixels serving as the light sources for the optical crosstalk, the luminance enhancing unit 136 enhances the luminance of those pixels which, from among the pixels serving as the light sources for the stereoscopic image, are not turned off. Meanwhile, as an amount of luminance enhancement, the luminance enhancing unit 136 can use a value stored in advance in the storage 120. That is, the amount of luminance enhancement can be a predetermined value, or can be a value calculated based on a positional relationship between the stereoscopic image and the pixels whose luminance is to be enhanced. With reference to FIG. 9, when the green light emitter G1 is turned off, the luminance of the green light emitters G2 and G3 is enhanced.

Meanwhile, alternatively, the luminance enhancing unit 136 can check whether the color of the pixels for the crosstalk is different from the color of the stereoscopic image, and only when they are different from each other, can enhance the luminance of the pixels which, from among the pixels serving as the light sources for the stereoscopic image, are not turned off, so as to compensate for the luminance of the stereoscopic image that is impacted as a result of turning off the pixels serving as the light sources for the optical crosstalk. The crosstalk becomes most noticeable in the case of having the different colors. Thus, by ignoring the crosstalk in the case of having the same color, the processing can be simpler.

Meanwhile, the relationship between the line of sight and the pixels whose luminance is to be enhanced or the color of the pixels whose luminance is to be enhanced can be stored in the storage 120. In that case, the luminance enhancing unit 136 can read such information from the storage 120 and perform the process of enhancing the luminance of those pixels which, from among the pixels serving as the light sources for the stereoscopic image, are not turned off. As a result, it becomes possible to reduce the calculation load while performing the processes in real time.

### Configuration of Display Device

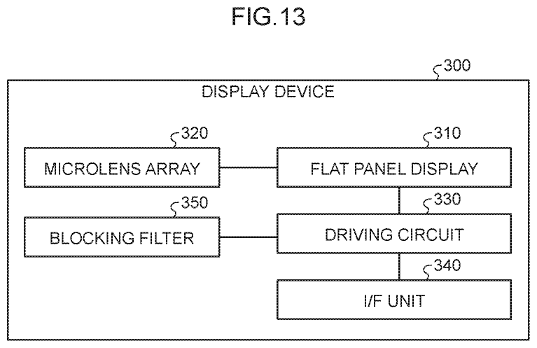

Explained below with reference to FIG. 13 is a configuration of the display device according to the present application. FIG. 13 is a diagram illustrating an exemplary configuration of the display device according to the present application. As illustrated in FIG. 13, the display device 300 according to the present application includes the flat panel display 310, the microlens array 320, a driving circuit 330, an I/F unit 340, and the blocking filter 350. However, it is not essential to include the blocking filter 350. The explanation about those constituent elements is given below in a sequential manner.

The flat panel display 310 is for displaying a variety of videos. The flat panel display 310 can be implemented using an organic EL display (EL stands for Electro Luminescence) or a micro LED display (LED stands for Light Emitting Diode).

The microlens array 320 is an optical device formed by integrating a large number of microlenses having the sizes in units of micrometers (μm) to millimeters (mm). The microlens array 320 is disposed in front of the pixels of the flat panel display 310. The microlens array 320 reproduces the light beams sent out from an object by varying the direction of light emitted from the flat panel display 310.

The driving circuit 330 provides control signals for driving the pixels of the flat panel display 310 and the pixels of the blocking filter 350. The driving circuit 330 includes a switching device for driving the flat panel display 310 and the blocking filter 350. That is, based on the control signals transmitted from the driving circuit 330, the luminance of the pixels of the flat panel display 310 and the blocking filter 350 are controlled.

The I/F unit 340 receives control signals from the control device 100. The I/F unit 340 can receive the control signals via a wired connection or a wireless connection established with the control device 100. In the case of the wired connection, a connection terminal compatible to a USB, an SDI, or an HDMI can be included. The wireless communication can be implemented using a wireless LAN as defined in IEEE 801.11.

The blocking filter 350 is capable of switching, by electrical signals, between the blockade of the light beams and the passage of the light beams. For example, the blocking filter 350 is disposed between the flat panel display 310 and the microlens array 320. The blocking filter 350 can be made of twisted nematic (TN) liquid crystal in which twisted liquid crystals (nematic liquid crystals) are sandwiched between two glass plates which are provided between two polarizing filters having orthogonal polarization directions. Meanwhile, the blockade of the light beams and the passage of the light beams can be switched by applying electrical signals to the liquid crystals by using thin film transistors (TFTs) corresponding to RGB subpixels of each pixel.

Alternatively, the blocking filter 350 can be implemented by using an electrochromic device in which an electrochromic (EC) material, which exhibits a reversible change in an optical property in response to an electrical signal, is used. Since the optical property in the electrochromic device is changed when a voltage is applied thereto, the blockade of the light beams and the passage of the light beams can be controlled by using electrical signals. Meanwhile, it is desirable that the pixel size of the blocking filter 350 is half the pixel size of the flat panel display 310.

### Image Display Method and Non-Transitory Storage Medium

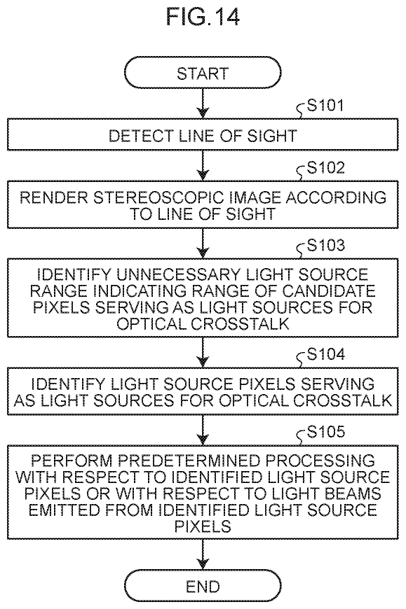

Explained below with reference to FIG. 14 is an image display method according to the present application. FIG. 14 is a flowchart for explaining about a flow of the image display method according to the present application. Thus, the explanation about the image display method according to the present application is given below with reference to the flow illustrated in FIG. 14.

Firstly, the image display device 1 detects the line of sight of the user (Step S101). Then, according to the detected line of sight, the image display device 1 renders a stereoscopic image in the display device 300 (Step S102). Subsequently, the image display device 1 identifies the unnecessary light source range indicating the range of the candidate pixels serving as the light sources for the optical crosstalk (Step S103). Then, the image display device 1 identifies the light source pixels serving as the light sources for the optical crosstalk (Step S104). Subsequently, the image display device 1 performs the predetermined processing with respect to the identified light source pixels or with respect to the light beams emitted from the identified light source pixels to prevent the light beams emitted from the identified light source pixels from passing through the position of the stereoscopic image (Step S105).

The image display method explained above can be implemented using the image display device 1, or can be implemented using a computer program that causes the controller 130 of the control device 100 of the image display device 1 to perform the processing.

In this way, the range of the candidate pixels serving as the light sources for the optical crosstalk can be identified according to the line of sight of the user, the pixels serving as the light sources for the optical crosstalk can be identified from that range, the predetermined processing can be performed with respect to the identified light source pixels or with respect to the light beams emitted from the identified light source pixels, and the light beams emitted from the identified light source pixels can be prevented from passing through the position of the stereoscopic image. Thus, it becomes possible to provide an image display method and a non-transitory storage medium that enable appropriate suppression of occurrence of crosstalk.

### Configuration and Effects

The image display device 1 according to the present application includes: the line of sight detecting unit 131 configured to detect the line of sight of the user; the display device 300 provided with pixels serving as light sources; the rendering unit 132 configured to render, in the display device 300, the stereoscopic image according to the line of sight of the user; the range identifying unit 133 configured to identify the unnecessary light source range indicating the range of the candidate pixels serving as the light sources for the optical crosstalk which represents the light beams which are emitted from the light sources other than the light sources for the rendered stereoscopic image and which passes through the position of the stereoscopic image; the pixel identifying unit 134 configured to identify, from among the pixels present in the unnecessary light source range, the light source pixels which represent the pixels serving as the light sources for the optical the crosstalk; and the light beam processing unit 135 configured to performs the predetermined processing with respect to the identified light source pixels or with respect to the light beams emitted from the identified light source pixels to prevent the light beams emitted from the identified light source pixels from passing through the position of the stereoscopic image.

With such a configuration, the range of the candidate pixels serving as the light sources for the optical crosstalk can be identified according to the line of sight of the user; the pixels serving as the light sources for the optical crosstalk can be identified from that range; the predetermined processing can be performed with respect to the identified light source pixels or with respect to the light beams emitted from the identified light source pixels to prevent the light beams emitted from the identified light source pixels from passing through the position of the stereoscopic image. Thus, it becomes possible to provide the image display device 1 that enables appropriate suppression of the occurrence of the crosstalk.

The light beam processing unit 135 of the image display device 1 according to the present application includes the turn-off instruction unit 1351 configured to turn off the light emission of the identified light source pixels.

With such a configuration, the range of the candidate pixels serving as the light sources for the optical crosstalk can be identified according to the line of sight of the user; the pixels serving as the light sources for the optical crosstalk can be identified from that range; and the light emission of the identified light source pixels can be turned off. Thus, it becomes possible to provide the image display device 1 that enables appropriate suppression of the occurrence of the crosstalk.

The display device 300 of the image display device 1 according to the present application further includes: the flat panel display 310 in which the pixels are disposed; the microlens array 320 disposed in front of the flat panel display 310; and the blocking filter 350 disposed between the flat panel display 310 and the microlens array 320. The light beam processing unit 135 of the image display device 1 according to the present application includes the block-out instruction unit 1352 configured to issue the instruction to the blocking filter 350 to block out the pixels of the blocking filter 350 which correspond to the positions of the identified light source pixels in the flat panel display.

With such a configuration, the range of the candidate pixels serving as the light sources for the optical crosstalk can be identified according to the line of sight of the user; the pixels serving as the light sources for the optical crosstalk can be identified from that range; and the instruction can be issued to block out those pixels of the blocking filter 350 which correspond to the positions of the identified light source pixels. Hence, it becomes possible to prevent the light beams emitted from the identified light source pixels from passing through the position of the stereoscopic image. Thus, it becomes possible to provide the image display device 1 that enables appropriate suppression of the occurrence of the crosstalk.

The range identifying unit 133 of the image display device 1 according to the present application is further configured to identify the unnecessary light source range based on the size of the pupils of the user and based on the positional relationship between the pupils of the user, the stereoscopic image, and the flat panel display which is provided in the display device and in which the pixels are disposed.

With such a configuration, the unnecessary light source range can be identified based on the size of the pupils of the user and based on the positional relationship between the pupils of the user, the stereoscopic image, and the flat panel display; such pixel as the straight line connecting the pixel with the center of the corresponding microlens passes through the stereoscopic image can be identified as the pixel contributing to the crosstalk; and the light emission of the identified light source pixels can be turned off. Thus, it becomes possible to provide the image display device 1 that enables appropriate suppression of the occurrence of the crosstalk.

The image display device 1 according to the present application further includes the luminance enhancing unit 136 configured to enhance the luminance of those pixels which, from among the pixels serving as the light sources for the stereoscopic image, are not turned off to compensate for the luminance of the stereoscopic image that is impacted as a result of turning off the pixels serving as the light sources for the optical crosstalk.

With such a configuration, it becomes possible to compensate for the luminance of the stereoscopic image that is impacted as a result of turning off the pixels serving as the light sources for the optical crosstalk. As a result, in addition to suppressing the occurrence of the crosstalk, the stereoscopic can be displayed clearly.

The image display method according to the present application includes: detecting the line of sight of the user; rendering, in the display device 300 provided with pixels serving as light sources, the stereoscopic image according to the line of sight of the user; identifying the unnecessary light source range indicating the range of the candidate pixels serving as the light sources for the optical crosstalk which represents the light beams emitted from the light sources other than the light sources for the rendered stereoscopic image and which passes through the position of the stereoscopic image; identifying, from among the pixels present in the unnecessary light source range, the light source pixels that represent the pixels serving as the light sources for the optical crosstalk; performing the predetermined processing with respect to the identified light source pixels or with respect to the light beams emitted from the identified light source pixels to prevent the light beams emitted from the identified light source pixels from passing through the position of the stereoscopic image.

With such a configuration, the range of the candidate pixels serving as the light sources for the optical crosstalk can be identified according to the line of sight of the user; the pixels serving as the light sources for the optical crosstalk can be identified from that range; the predetermined processing can be performed with respect to the identified light source pixels or with respect to the light beams emitted from the identified light source pixels to prevent the light beams emitted from the identified light source pixels from passing through the position of the stereoscopic image. Thus, it becomes possible to provide the image display method that enables appropriate suppression of the occurrence of the crosstalk.

A non-transitory storage medium that stores a computer program according to the present application causes a computer to execute: detecting the line of sight of the user; rendering, in the display device 300 provided with pixels serving as light sources, the stereoscopic image according to the line of sight of the user; identifying the unnecessary light source range indicating the range of the candidate pixels serving as the light sources for the optical crosstalk which represents the light beams emitted from the light sources other than the light sources for the rendered stereoscopic image and which passes through the position of the stereoscopic image; identifying, from among the pixels present in the unnecessary light source range, the light source pixels that represent the pixels serving as the light sources for the optical crosstalk; performing the predetermined processing with respect to the identified light source pixels or with respect to the light beams emitted from the identified light source pixels to prevent the light beams emitted from the identified light source pixels from passing through the position of the stereoscopic image.

With such a configuration, the range of the candidate pixels serving as the light sources for the optical crosstalk can be identified according to the line of sight of the user; the pixels serving as the light sources for the optical crosstalk can be identified from that range; the predetermined processing can be performed with respect to the identified light source pixels or with respect to the light beams emitted from the identified light source pixels to prevent the light beams emitted from the identified light source pixels from passing through the position of the stereoscopic image. Thus, it becomes possible to provide the non-transitory storage medium that stores the computer program that enables appropriate suppression of the occurrence of the crosstalk.

According to the present application, it becomes possible to provide an image display apparatus, an image display method and a non-transitory storage medium that enable appropriate suppression of the occurrence of crosstalk.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

An image display device, an image display method, and a non-transitory storage medium according to the present application can be applied to an image display device, an image display method, and a non-transitory storage medium that enable appropriate suppression of occurrence of crosstalk.

What is claimed is:

1. An image display device comprising:
a display device provided with pixels serving as light sources;
a memory that is configured to store computer executable instructions; and
a processor that is configured to execute the computer executable instructions to perform operations, comprising:
detecting a line of sight of a user;
rendering, in the display device, a stereoscopic image according to the line of sight of the user;
identifying an unnecessary light source range indicating a range of candidate pixels serving as light sources for an optical crosstalk which represents light beams emitted from the light sources other than the light sources for the rendered stereoscopic image and which passes through a position of the stereoscopic image;
identifying, from among the pixels present in the unnecessary light source range, the light source pixels which represent the pixels serving as the light sources for the optical crosstalk; and
performing a predetermined processing with respect to the identified light source pixels or with respect to the light beams emitted from the identified light source pixels to prevent the light beams emitted from the identified light source pixels from passing through the position of the stereoscopic image.

2. The image display device according to claim 1, wherein the perfoming further comprises turning off light emission of the identified light source pixel.

3. The image display device according to claim 1, wherein the display device further comprises:
a flat panel display in which the pixels are disposed;
a microlens array disposed in front of the flat panel display; and
a blocking filter disposed between the flat panel display and the microlens array, wherein
the perfoming further comprises issuing an instruction to the blocking filter to block out pixels of the blocking filter which correspond to positions of the identified light source pixels in the flat panel display.

4. The image display device according to claim 1, wherein the identifying of the unnecessary light source range further comprises identifying the unnecessary light source range based on a size of pupils of the user and based on a positional relationship between the pupils of the user, the stereoscopic image, and a flat panel display which is provided in the display device and in which the pixels are disposed.

5. The image display device according to claim 1, further comprises enhancing luminance of pixels which are not turned off to compensate for luminance of the stereoscopic image that is impacted as a result of turning off the pixels serving as the light sources for the optical crosstalk.

6. The image display device according to claim 1, wherein the identifying of the unnecessary light source range further comprises identifying a range corresponding to a predetermined angle around the line of sight as the unnecessary light source range by taking into account a discriminative field of vision representing a range within which a sharp vision can be gained without moving pupils of the user.

7. The image display device according to claim 2, wherein the turning off further comprises checking whether color of the pixel for the crosstalk is different from color of the stereoscopic image, and turning off the pixel for the optical crosstalk when the color of the optical crosstalk is different from the color of the stereoscopic image.

8. The image display device according to claim 3, wherein a size of a single pixel in the blocking filter is half a size of a pixel of the flat panel display.

9. The image display device according to claim 5, wherein the enhancing further configured to check whether color of the pixels for the crosstalk is different from color of the stereoscopic image, and enhancing, when they are different from each other, the luminance of the pixels which, from among the pixels serving as the light sources for the stereoscopic image, are not turned off, so as to compensate for the luminance of the stereoscopic image that is impacted as a result of turning off the pixels serving as the light sources for the optical crosstalk.

10. An image display method comprising:
detecting a line of sight of a user;
rendering, in a display device provided with pixels serving as light sources, a stereoscopic image according to the line of sight of the user;
identifying an unnecessary light source range indicating a range of candidate pixels serving as light sources for an optical crosstalk which represents light beams emitted from the light sources other than the light sources for the rendered stereoscopic image and which passes through a position of the stereoscopic image;
identifying, from among pixels present in the unnecessary light source range, light source pixels which represent pixels serving as the light sources for the optical crosstalk; and
performing a predetermined processing with respect to the identified light source pixels or with respect to the light beams emitted from the identified light source pixels to prevent the light beams emitted from the identified light source pixels from passing through the position of the stereoscopic image.

11. A non-transitory storage medium that stores a computer program that causes the computer to execute:
detecting a line of sight of a user;
rendering, in a display device provided with pixels serving as light sources, a stereoscopic image according to the line of sight of the user;
identifying an unnecessary light source range indicating a range of candidate pixels serving as light sources for an optical crosstalk which represents light beams emitted from the light sources other than the light sources for the rendered stereoscopic image and which passes through a position of the stereoscopic image;
identifying, from among pixels present in the unnecessary light source range, light source pixels which represent pixels serving as the light sources for the optical crosstalk; and
performing a predetermined processing with respect to the identified light source pixels or with respect to the light beams emitted from the identified light source pixels to prevent the light beams emitted from the identified light source pixels from passing through the position of the stereoscopic image.
